(19) United States
(12) Patent Application Publication
(10) Pub. No.: US 2025/0255699 A1
(43) Pub. Date: Aug. 14, 2025

(54) DENTAL IMPLANT

(71) Applicant: SCHUTHINK LLC, New York, NY (US)

(72) Inventor: Stephen J. Chu, New York, NY (US)

(21) Appl. No.: 19/050,963

(22) Filed: Feb. 11, 2025

Related U.S. Application Data
(60) Provisional application No. 63/552,786, filed on Feb. 13, 2024.

(51) Int. Cl. A61C 8/00

(52) U.S. Cl. CPC A61C 8/0051; A61C 8/0022

(57) ABSTRACT

A dental implant has a coronal portion forming an upwardly converging tapered cylinder. First threads in a first direction are located on an outer surface of the coronal portion. A scalloped implant-abutment interface is provided at an upper end of the coronal portion. The dental implant also has an apical portion forming a downwardly converging tapered cylinder. Second threads in a second direction are located on an outer surface of the apical portion. The second direction is preferably opposite to the first direction. The first threads are preferably shallower than the second threads.

### CROSS-REFERENCE TO RELATED APPLICATION

This application claims the benefit of the filing date of U.S. Provisional Patent Application No. 63/552,786, filed Feb. 13, 2024, which is hereby incorporated herein by reference in its entirety.

### TECHNICAL FIELD

The present disclosure relates generally to the field of implant dentistry, oral surgery, and periodontics; in particular, to a dental implant having a convergent coronal main body portion and a scalloped prosthetic implant-abutment interface that is particularly useful for maxillary anterior post-extraction sockets for both single and multiple unit use.

### BACKGROUND

In an era of dentistry driven by high esthetic demands, immediate treatment protocols and standards, flapless post-extraction dental implant placement with hard and soft tissue loss can pose a considerable esthetic, surgical, and/or restorative challenge. In vivo studies have reported that dental implants placed into post-extraction sockets do not alter the wound healing and remodeling process of the socket nor preserve the labial bone plate especially in the anterior region of the mouth where the labial bone plate is approximately 0.5-1.0 millimeters in thickness post tooth extraction. Conventional tapered dental implants that are too wide in diameter at the coronal aspect of the implant body and that completely fill the extraction socket or that are placed too close to the labial bone plate will result in loss of the labial bone after remodeling. This dimensional change can lead to ridge collapse, thinning of the peri-implant soft tissues, and gingival tissue discoloration due to labial bone plate loss and shine through of the implant threads. It is important to consider proper hard and soft tissue management when managing flapless post-extraction dental implants in the esthetic zone.

Several clinical procedures have been proposed to assist in addressing the disadvantages associated with flapless post-extraction dental implant placement and the subsequent potential hard and soft tissue loss. In vivo studies have shown that dental implant position and diameter play a significant role in maintaining the labial bone plate height with full osseointegration, without the aid of a bone or hard tissue graft. The former strategy being palatal dental implant positioning within the extraction socket and ‘gap distance’ between the facial surface of the dental implant and residual labial plate thereby allowing a blood clot to fill the gap and organize into granulation tissue predetermined to form new bone. The latter strategy uses smaller diameter dental implants to create a favorable coronal gap distance for the labial blood clot. Thus, new labial bone plate formation may be achieved using smaller diameter dental implants placed in a palatal position within the extraction socket. In addition, more recent studies suggest that a coronal gap distance >2.0 mm is required to achieve a favorable net labial plate thickness of>1.5 mm which would be sufficient for long term stability of the bone.

The labial bone plate can collapse roughly 1.0-2.0 millimeters even though osseointegration can be achieved. Minimizing labial bone plate collapse is important to achieve satisfactory esthetic results. Studies have shown that bone grafting the gap can limit the amount of ridge shape change both clinically and on cone beam computer tomography (CBCT) to <0.5 millimeters. Xenografts and allografts have been analyzed in these studies. Therefore, it is of clinical significance to maintain a gap distance after dental implant placement for not only blood clot formation but also bone graft placement to maximize esthetic outcomes of dental implants placed into maxillary anterior post-extraction sockets. The graft biomaterials act as a space filler or scaffold to maintain the volume of the blood clot for new bone formation.

One problem with using smaller diameter dental implants in maxillary anterior extraction sockets is decreased primary stability of the dental implant since the lateral surrounding walls of the extraction socket are rarely completely engaged, nor should they be due to socket remodeling. Primary stability of dental implants in extractions socket should achieve a minimum of 35 Newton-Centimeters (Ncm) of insertion torque to reach 96% survival rate. One technique to achieve adequate primary stability (e.g., >35 Ncm) is engaging the apical-palatal bone beneath the floor of the nose anatomically, with smaller diameter dental implants. However, there are limitations in apical bone beyond the root apex to engage. In addition, longer dental implant lengths are required (e.g., 15 millimeters) to obtain satisfactory primary stability, though there is an increased risk of perforating the base/floor of the nose. Another strategy in achieving adequate initial primary stability in extraction sockets is under sizing the osteotomy and using a wider diameter implant with the trade-off being a decreased gap distance between the dental implant and labial bone plate with a conventional tapered design. Also, osseodensification burs can be used to condense soft or trabecular bone laterally thereby increasing initial implant stability.

Prior dental implant designs typically include threaded or screw shapes with a tapered body from coronal to apical; the coronal aspect of the dental implant head being wider at the top versus a narrower diameter at the lower portion or end of the dental implant. This typical design mimics the natural extraction socket in the patient's mouth in shape and form. Anatomically, the apical-palatal area of the extraction socket has a greater amount of bone volume and coronally the labial bone is thinner. As the apical region of typical tapered dental implants is smaller in diameter (e.g., as compared with the coronal region of typical dental implants), the apical region may not offer enough surface area to achieve adequate primary stability when installed, especially when using a surgical strategy involving a decreased dental implant length for fear of perforating the base/floor of the nose. In addition, typical tapered dental implants are wider at the top (e.g., coronally) thereby decreasing the gap distance between the upper neck of the dental implant and the extraction socket. Consequently, wider diameter tapered dental implants are typically used to increase dental implant primary stability (e.g., a 5.0 millimeter dental implant might be used instead of a 4.0 millimeter dental implant), thereby decreasing the labial gap distance and thus impeding subsequent blood clot formation with bone grafting, which is ideal for forming new labial bone plate between the dental implant and the extraction socket.

Another factor in dental implant design relative to dental implant placement is that with typical tapered dental implants being wider at the top, this negatively impacts palatal placement. As the dental implant is placed and driven into the extraction socket apically, the wider neck may engage the palatal bone plate and may bounce/move or angulate the dental implant more to the facial aspect of the extraction socket. This can result in undesirable labial placement and angulation of the dental implant and potentially a decreased gap distance between the dental implant and the facial aspect/side of the extraction socket.

Another factor in dental implant design is dental implant position relative to adjacent teeth. Some studies have shown that proximity of adjacent dental implants to teeth can cause interproximal attachment (e.g., of hard and/or soft tissue) or papilla loss and consequently cause black interdental triangles between teeth and dental implants.

Another factor in dental implant design is dental implant position relative to adjacent dental implants. It is not uncommon that when two adjacent implants are placed side by side, that the interdental papilla shrinks since there is absence of supracrestal gingival fibers or attachment apparatus to hold the papilla in place. In addition, the interproximal bone scallop between adjacent anterior teeth is about 3.0 millimeters from interdental to midfacial. More relevant is the fact that present non-scalloped implant designs have a flat interproximal profile that requires 3.0 millimeters of bone scallop and 4.5-5.0 millimeters of soft tissue height to be maintained and preserved after implant placement. Biologically, this may not be achievable hence loss, shrinkage, or atrophy (shorter height) of papilla tissue between adjacent anterior implant in the esthetic area of the dentition.

Some previous dental implants have attempted to provide a singular or a few segmented interrupted gaps between the coronal portion of the dental implant and the osteotomy site by eliminating a side portion of the dental implant making a flat cutout portion. However, during installation, such dental implants must be installed with a specific rotational position relative to the socket such that the flat side is aligned with the buccal bone plate and/or the adjacent tooth in the mouth of the patient. Otherwise, the dental implant will not promote bone growth in the desired location.

Some previous implants have had a profiled implant-abutment interface used in edentulous sites to follow the contour of the healed bone ridge since frequently it is not inherently flat, by nature.

A previous scalloped implant design was designed with equidistant symmetrical facial and palatal curves or slopes to follow the contour of the soft tissue to maintain the interproximal soft tissue height. This implant was a tissue level design with a 2.0 millimeter polished collar.

Recent studies looking at immediate implant placement into maxillary anterior extraction sockets have shown that the ability to deliver a straight channel or direct screw-retained restoration is in the range of 10 percent to 24 percent of the time. Conversely, the risk of apical socket perforation being in the range of 76 percent to 90 percent, with a mean average of 82 percent.

Therefore, a need exists for dental implants with relatively narrower convergent or constricted coronal portions promoting maximum crestal bone growth in the coronal portion of the extraction socket around the implant body and strategic locations such as the labial and interproximal regions to maintain the natural bone and gingival scallop of the hard and soft tissues found in nature in the anterior maxilla and either conventional diameter or slightly wider apical portions of the implant body to increase primary stability of the dental implant. The present disclosure is directed to solving these problems as well as addressing other needs.

### SUMMARY

The present disclosure pertains to a dental implant designed to improve the fit and function of dental implants by incorporating specific structural features. The implant includes two main sections: (1) a coronal portion, or upper portion, of the implant that is formed as an upwardly converging tapered cylinder, with threads on its outer surface in a first direction. It also features a scalloped implant-abutment interface at the upper end, which is designed to follow the natural bone crest of a patient's extraction socket. The interface is asymmetric, with varying distances from the facial, interproximal, and palatal surfaces. The dimensions of the scallop may be specifically defined, such as a 3.0 mm distance from the facial to interproximal surface and 1.5 mm from the interproximal to the palatal surface; and (2) an apical portion, or lower portion, of the implant that is formed as a downwardly converging tapered cylinder with threads in a second direction, opposite to the first. The thread depth and pitch are preferably designed to provide stability and a secure fit, with the second threads being deeper than the first.

Additional features of the implant may include a variation in thread depth between the coronal and apical portions, with the coronal portion being shallower. The implant's overall height may be designed such that the coronal portion constitutes 30% to 50% of the total height, and the apical portion makes up 50% to 70%. This design aims to improve the implant's integration with the surrounding bone, ensuring better stability and a more natural fit for patients receiving dental implants.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a front left perspective view of a dental implant according to the present disclosure;

FIG. 2 is a left side view of the dental implant shown in FIG. 1;

FIG. 3 is a front view of the dental implant shown in FIG. 1;

FIG. 4 is a rear side view of the dental implant shown in FIG. 1; and

FIG. 5 is a top front perspective view of the dental implant shown in FIG. 1.

### DETAILED DESCRIPTION

In the present disclosure, like reference numbers refer to like elements throughout the drawings, which illustrate various exemplary embodiments of the present disclosure.

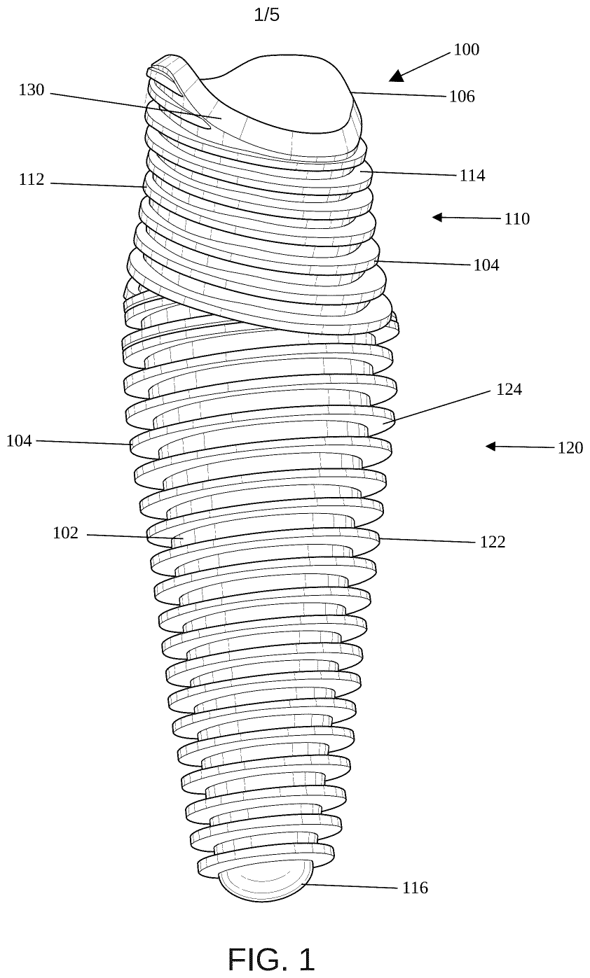

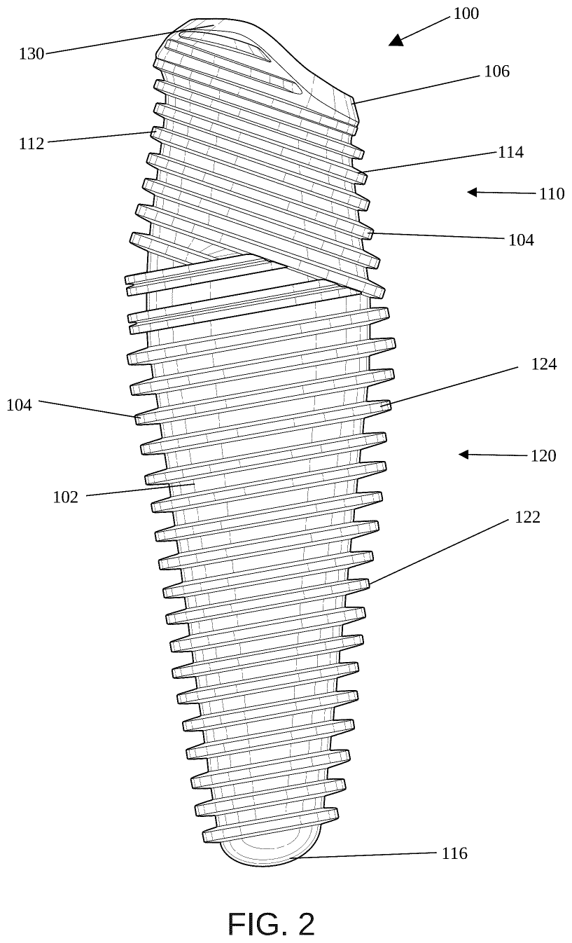

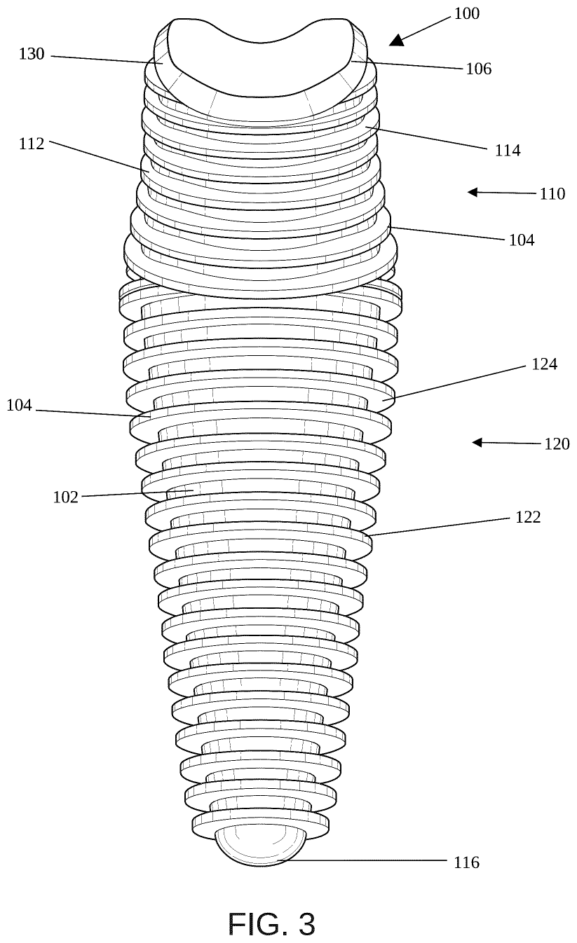

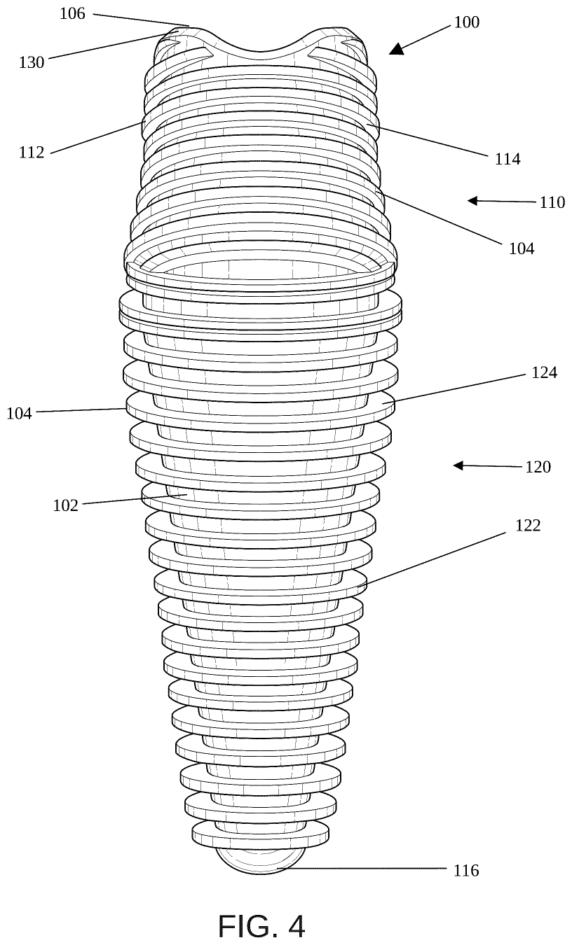

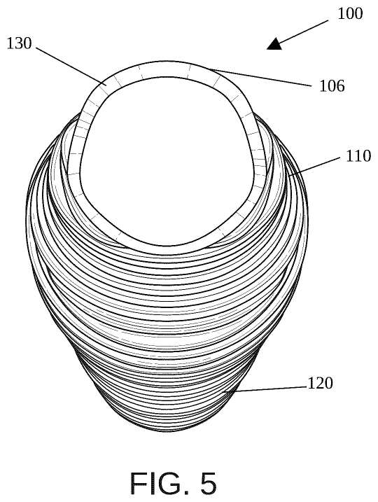

Referring now to FIGS. 1 to 6, a dental implant 100 includes a body 102 having a threaded surface 104 thereon. The body has an upper portion 110 (the coronal portion) that extends 50-30% of the height of the dental implant 100 and a lower portion 120 (the apical portion) that extends 50-70% of the height of the dental implant 100. The upper portion 110 of the body includes a generally convergent tapered circular coronal region. The lower portion 120 of the body includes a generally convergent tapered apical region. The apex 116 is rounded to limit implant depth.

A maximum outer diameter of the body 102 is greater than (i) a maximum outer diameter of the upper portion 110 and (ii) a maximum outer diameter of the lower portion 120. The threaded surface 104 is on the body 102 within at least the upper portion 110 of the body 102 and the lower portion 120 of the body 102. The dental implant 100 has a convergent reduced diameter body configuration where a significant portion (e.g., 30 percent to 50 percent) of the length of the body diameter decreases in diameter coronally (e.g., in a direction towards the uppermost end, coronal end, or top of the dental implant 100) in the upper portion 110. Such a configuration allows primary stability of a conventional or wider diameter implant yet substantially increases coronal gap distance between a top portion 106 of the dental implant 100 and the extraction socket (e.g., where the labial bone plate is thin as compared with the bone more apical-palatal in the extraction socket receiving the dental implant 100). The gap distance extends 360 degrees around the dental implant 100 with flexibility in dental implant placement to achieve a relatively greater gap distance on the labial side (e.g., as compared with the gap distance on the palatal side). In addition, the convergent diameter coronal neck (i.e., upper portion 110) of the dental implant 100 eliminates and/or reduces a buccal ‘bounce effect’ during installation and unwanted excessive facial implant angulation (e.g., even with unintended palatal placement).

Preferably, the dental implant 100 has a change in coronal diameter that aids in maintaining a minimum interproximal distance between teeth and the dental implant 100 of about 1.5 millimeters on either side, even without platform switching of the dental implant-abutment connection.

Preferably, the dental implant 100 includes a macro thread configuration with an aggressive thread depth at the apical end, i.e., lower portion 120, of 2.0-2.6 mm, shallow thread depth at the coronal end, i.e., upper portion 110, of 0.3-0.5 mm, and a decreased thread pitch of 0.5-0.7 mm throughout the length of dental implant 100. This aids in increasing primary stability of the dental implant 100 since there is an increased number of threads per unit length of bone thereby increasing the number of threads contacting bone.

Preferably, the dental implant 100 aids in hard tissue maintenance and preservation by providing a relatively increased labial gap distance between the coronal portion of the dental implant 100 and at least a portion of the extraction socket. The dental implant 100 includes a convergent taper in diameter from the lower portion 120 to the upper portion 110 as compared with conventional tapered dental implants that are wider coronally that results in a narrower coronal portion. As such, the upper portion 110 of the dental implant 100 provides a relatively larger coronal gap distance between the dental implant 100 and the extraction socket at the crest where the bone is the thinnest. In addition, the relatively smaller diameter of the dental implant 100 at the coronal end thereof eliminates and/or reduces a buccal ‘bounce effect’ when the dental implant 100 is positioned more palatal in the extraction socket.

Preferably, the upper portion 110 of the dental implant 100 has a scalloped implant-abutment interface 130 interproximally to follow the contour of the bone surrounding the extraction socket to maintain its height and shape in those interdental areas. Notwithstanding, the relatively smaller diameter and scalloped contour of the implant-abutment interface 130 of the dental implant 100 promotes ease of fitting prosthetic components since the interproximal and palatal aspects of the implant are not deep subcrestally, but equicrestal or slightly subcrestal.

Preferably, the dental implant 100 is provided for installation in a maxillary anterior extraction socket in a mouth of a patient. The socket is formed by bone. The exterior surface 112 of the upper portion 110 is sized and configured to promote circumferential bone growth of at least a portion of the bone of the socket in the mouth of the patient after installation of the dental implant 100 therein. The exterior surface 122 of the lower portion 120 is sized and configured to anchor the dental implant 100 in the bone of the socket in the mouth of the patient. The exterior surface 112 of the upper portion 110 is generally cylindrical.

Preferably, the dental implant 100 includes a body 102, an interior bore (not shown), and a non-rotational feature. The body 102 has an upper portion 110 with shallow threads, and a lower portion 120 that is threaded for anchoring the dental implant 100 in bone of a patient. The threaded coronal portion, i.e., upper portion 110, is generally convergent, tapered, and circular in form. The threaded upper portion 110 has shallow threads 114 that follow the contour and profile of the scalloped abutment interface. These shallow threads 114 align in the opposite direction of the apical threads 124. The interior bore is formed in the body 102 and has a threaded portion for receiving a screw configured to hold an abutment in engagement with the dental implant 100 in a removable and retrievable fashion, as known in the art. The non-rotational feature is configured to engage the abutment in a non-rotational fashion yet follow the scallop or profile of the implant head. The non-rotational feature is positioned opposite from a lowermost end of the apical portion of the body 102.

The dental implant 100 of the present disclosure addresses a number of deficiencies in implant dentistry, specifically, in current maxillary anterior extraction sockets, including loss of the interdental papillae between multiple adjacent implants, loss of the interdental papilla between a natural tooth and adjacent implant, and loss of labial bone plate thickness and volume.

The dental implant 100 of the present disclosure provides a number of benefits over prior solutions. Prior implants were designed for the treatment of edentulous healed ridges, not extraction sockets in the anterior maxilla. Prior scalloped implant designs were tissue level implants, not bone level implants with a 2.0 mm polished collar as well as symmetrical and equidistant from the facial surface to the interproximal surface to the palatal surface. Prior implant designs with a scalloped or profiled abutment interface were divergent or wider or outwardly tapered at the top of the implant where the bone crest is the thinnest in volume and dimension.

The dental implant 100 of the present disclosure includes a number of features that are not present in prior solutions. The convergent coronal tapered body portion, i.e., upper portion 110, has a 30%-50% implant length from the implant body from the abutment interface (i.e., 30%-50% of the total height of the body 102), which allows a greater circumferential coronal gap for placement of biologic materials to thicken the hard and soft tissues. The interproximal scallop is asymmetric and not equidistant from the facial surface to the interproximal surface to the palatal surface (all of the dental implant 100). The facial surface to the interproximal surface scallop is 3.0 mm and the interproximal surface to the palatal surface is 1.5 mm. This implant-abutment interface design follows the natural scallop of the bone crest of the extraction socket to maintain the crest of bone. This is especially true interdentally where frequently the bone resorbs due to lack of thickness and height from the prosthetic interface of flat, non-profiled implants that can be 3.0 mm subcrestal. This bone level scalloped implant design allows the interproximal bone to be supported since the interface is equicrestal, not subcrestal. The convergent coronal tapered portion (i.e., upper portion 110) of the body 102 with shallow threads 114 allows easier maintenance in situations of periimplantitis and crestal bone loss. Shallower threads at the crest are also less plaque retentive and could mitigate the progression of periimplant disease. The coronal shallow thread pattern (i.e., that form the shallow threads 114) is in an opposite direction to the deeper apical thread pattern (i.e., that form the apical threads 124) for greater secondary stability of the dental implant 100 after osseointegration. A biaxial abutment connection feature in situations where apical socket perforation is at risk.

The dental implant 100 of the present disclosure has the primary stability of a conventional or wide diameter implant with the coronal gap distance of a smaller diameter implant, a greater labial bone plate thickness due to convergent tapered coronal portion of implant body, and a greater tooth-implant distance and consequently papilla preservation due to convergent tapered coronal portion of implant body. The dental implant 100 has a greater implant-implant distance and consequently papillae preservation with multiple adjacent implants due to convergent tapered coronal portion of implant body and scalloped abutment connection. The dental implant 100 also has resistance to periimplantitis progression due to shallow coronal threads roughly 30-50% implant body length form the implant-abutment interface and easier hygiene maintenance due to convergent coronal body design.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A dental implant, comprising:
a coronal portion forming an upwardly converging tapered cylinder, with first threads in a first direction on an outer surface of the coronal portion and a scalloped implant-abutment interface at an upper end of the coronal portion; and
an apical portion forming a downwardly converging tapered cylinder, with second threads in a second direction on an outer surface of the apical portion.

2. The dental implant of claim 1, wherein the second direction is opposite to the first direction.

3. The dental implant of claim 1, wherein the first threads are shallower than the second threads.

4. The dental implant of claim 1, wherein the second threads have a thread depth between 2.0 mm and 2.6 mm.

5. The dental implant of claim 1, wherein the first threads have a thread depth between 0.3 mm and 0.5 mm.

6. The dental implant of claim 1, wherein the first threads and the second threads have a decreased thread pitch of between 0.5 and 0.7 mm from a bottom of the apical portion to a top of the coronal portion.

7. The dental implant of claim 1, wherein the dental implant has a predetermined height and wherein the coronal portion has a height consisting of 30% to 50% of the predetermined height.

8. The dental implant of claim 1, wherein the dental implant has a predetermined height and wherein the apical portion has a height consisting of 50% to 70% of the predetermined height.

9. The dental implant of claim 1, wherein the scalloped implant-abutment interface is asymmetric and not equidistant from a facial surface of the interface to an interproximal surface of the interface to a palatal surface of the interface.

10. The dental implant of claim 9, wherein a distance from the facial surface to the interproximal surface is 3.0 mm.

11. The dental implant of claim 9, wherein a distance from the interproximal surface to the palatal surface is 1.5 mm.

12. The dental implant of claim 1, wherein the scalloped implant-abutment interface follows a natural scallop of a bone crest of an extraction socket in a mouth of a patient.
